(19) United States
(12) Patent Application Publication
(10) Pub. No.: US 2005/0158428 A1
(43) Pub. Date: Jul. 21, 2005

(54) Stuffed edible product and methods and apparatus for making the same

(75) Inventor: Norman E. Jager, Albany, OR (US)

Correspondence Address: KLARQUIST SPARKMAN, LLP, 121 SW SALMON STREET, SUITE 1600, PORTLAND, OR, 97204, US

(73) Assignee: Oregon Freeze Dry, Inc.

(21) Appl. No.: 11/035,948

(22) Filed: Jan. 14, 2005

Related U.S. Application Data
(60) Provisional application No. 60/537,186, filed on Jan. 16, 2004.

(51) Int. Cl. A23G 3/00

(52) U.S. Cl. 426/94

(57) ABSTRACT

A stuffed edible food product and methods and apparatus for making the stuffed edible food product are disclosed. The stuffed edible food product can be lyophilized and can include an edible article with a wall structure at least partially defining at least one void and an edible filling positioned within the at least one void. The method can include reducing the puncture resistance of the wall structure, introducing the edible filling into the at least one void and lyophilizing the stuffed food product.

### CROSS REFERENCE TO RELATED APPLICATION

This application claims the benefit of U.S. Provisional Application No. 60/537,186, filed Jan. 16, 2004, which is incorporated herein by reference.

### FIELD

Disclosed herein are methods and apparatus for making edible products that include a first edible material stuffed inside at least one void defined by a second edible material.

### BACKGROUND

Edible products made from at least two different materials can provide variation in texture and/or taste that cannot be achieved with products made from one material. Accordingly, there continues to be a need for novel food products, and methods for making such products, that include at least two different edible materials.

### SUMMARY

Disclosed herein are methods for making an edible product. In one approach, the method involves preparing a first edible article having a wall structure that defines at least one void so as to reduce the puncture penetration resistance of the wall structure, introducing a second edible material into the at least one void of the first edible article to produce a stuffed food product, and lyophilizing the stuffed food product. According to one variant, the first edible article is at least partially inflated with air prior to the introduction of the second edible material. In a specific example, the first edible article may be pea pods, peppers, tomatoes, or bean pods, and the second edible material may be a paste or puree.

Also disclosed herein are lyophilized edible products made by the method described above.

In addition, apparatus for making such edible products are disclosed. One example of the apparatus includes a container, at least one edible filling delivery element coupled to the container, a pressurized gas supply, and a pressurized gas line coupled to the pressurized gas supply and positioned adjacent to the edible filling delivery element.

### BRIEF DESCRIPTION OF THE DRAWING

FIG. 1 depicts a device for introducing one food material into a void defined in a second food material.

### DETAILED DESCRIPTION OF SEVERAL EXAMPLES

For ease of understanding, the following terms used herein are described below in more detail:

“Lyophilization” (also known as freeze-drying) refers to a technique for removing moisture from a wet material by freezing it and subsequently subliming moisture from it under reduced pressure. In this process, a suspension, solution or wet solid is frozen, and ice crystals in the frozen product are removed through a sublimation process at a reduced temperature and pressure that transforms ice directly into a vapor. The resulting freeze-dried product is a porous mass about the same size and shape as the original frozen mass. It has good stability and efficient rehydration when placed in solvent (usually water), and maintains flavor and texture similar to the original material.

Typical freeze-drying operations involve three steps: freezing, removal of unbound liquid (primary drying) by sublimation from a solid directly into a vapor, and desorption of bound solvent (secondary drying) from a liquid into a vapor. Materials to be freeze-dried may be complex mixtures of solvent(s) and other substances that are cooled to form ice crystals. With further cooling, the unbound solvent becomes a vitreous mass. When the entire mass is solidified, all unbound solvent has been transformed into ice. Bound solvent, however, remains fixed as a liquid within the internal structure of the material and is not frozen.

During the sublimation phase of freeze-drying, the frozen material is exposed to a vacuum, and heat is applied to the ice crystals to sublime them. The temperature and pressure of the lyophilization process is carefully controlled such that the frozen mass is maintained below the eutectic temperature at which the mass begins to melt. See, for example, U.S. Pat. No. 4,616,047 and U.S. Pat. No. 4,001,944, in which lyophilization occurs below the initial melting temperature of the mass. Removing unbound solvent during the primary drying step is therefore accomplished without exceeding the eutectic temperature of the composition.

In other lyophilization processes, a partially collapsed matrix network of a product can be vacuum dried at least partially below the equilibrium freezing point of the matrix. Such a process is shown in U.S. Pat. No. 5,298,261.

Lyophilization of edible products can be performed in any fashion, for example as shown in U.S. Pat. No. 3,894,157; U.S. Pat. No. 4,361,589; U.S. Pat. No. 5,616,355; and PCT published patent application WO 01/33980.

The above term descriptions are provided solely to aid the reader, and should not be construed to have a scope less than that understood by a person of ordinary skill in the art or as limiting the scope of the appended claims.

The singular terms “a,” “an,” and “the” include plural referents unless context clearly indicates otherwise. Similarly, the word “or” is intended to include “and” unless the context clearly indicates otherwise. The word “comprises” indicates “includes.”

The edible article that can be stuffed with edible filling according to the methods described herein can be any food material that includes a wall structure that defines at least one void. The void typically is a protective void for seeds or similar propagating plant material that naturally exists in the edible article. The wall structure should have sufficient structural strength to retain the edible filling without rupturing. Examples of edible articles having suitable wall structures and void(s) for stuffing include pea pods (particularly sweet pea pods), peppers (such as, for example, Jalapeno), tomatoes (such as, for example, cherry tomatoes), and bean pods (such as, for example, soy bean pods). Such edible articles also typically include at least one void that is entirely encompassed by a wall structure that does not have any openings or passages of sufficient diameter through which the edible filling could leak. The food material that naturally exists inside the edible articles may or may not be removed prior to stuffing. For example, in the case of sweet pea pods, it is not necessary to remove the peas prior to stuffing. However, in the case of peppers or tomatoes it may be helpful to remove at least a part of the seeds and surrounding food material prior to stuffing.

The edible article may be prepared for stuffing by subjecting the food article to at least one treatment that reduces the puncture penetration resistance of the wall structure. Such treatments may soften the wall structure and/or reduce the surface tension of the wall structure. Illustrative treatments include blanching and/or inflation.

Blanching involves subjecting the edible article to steam and/or hot water for a period of time to soften the wall structure and prepare the food article for eventual lyophilization. For example, the edible article may be blanched for about 30 seconds to about 2 minutes in water at a temperature of about 170° F. to about 210° F.

Inflation involves introducing air or another gas into the void within the edible article. The introduced air or gas decreases the surface tension of the wall structure resulting in decreased puncture resistance of the wall structure. For example, untreated sweet pea pods have a relatively flat shape. An inflated pea pod assumes a more oblong or elliptical shape which decreases the surface tension of the wall structure. In addition, the introduced air or gas can at least partially increase the volume of the void thereby facilitating the subsequent introduction of the edible filling. However, it is not necessary to inflate the edible article to the extent that the volume of the void matches the volume subsequently occupied by the edible filling.

The air or gas can be introduced into the void by any technique. For example, the wall structure can be punctured with a needle having an air or gas passage that is coupled to a pressurized air or gas supply. Typically, an air or gas pressure that is only marginally greater than atmospheric pressure should be sufficient to inflate the edible article. For example, a pressure of about 0.5 to about 5.0 psi can be used for inflating the edible article.

The edible filling that is introduced into the void in the edible article may be any edible material that provides taste and/or texture to the edible product that is consumed by the end user. Such filling should have sufficiently low viscosity so that it is either flowable under refrigeration or flowable at room temperature and moisture. Refrigeration, which can be a temperature between about 5° C. and about 18° C., may be necessary to prevent spoilage of certain edible fillings. Other suitable edible fillings may not require refrigeration and may be flowable only at room temperature and moisture. In some embodiments, the filling may be in the form of a paste or thick liquid mixture or suspension. Illustrative fillings include purees made from, for example, corn, onion, mushroom, imitation crab, meat, seafood, vegetable, fruit and mixtures thereof; peanut butter; and cheese. The amount of the edible filling introduced into the void may vary. For instance, the edible filling may occupy substantially all of the volume of the void or it may occupy only a portion of the volume of the void. Introduction of the edible filling expands the edible article that defines the void, but not to the extent that the edible article ruptures or that the filling leaks out from the edible article.

The edible filling may be introduced into the edible article in any suitable manner. For example, a container that can hold the edible filling may be provided. Attached or coupled to the container may be an element for delivering the edible filling from the container into the edible article.

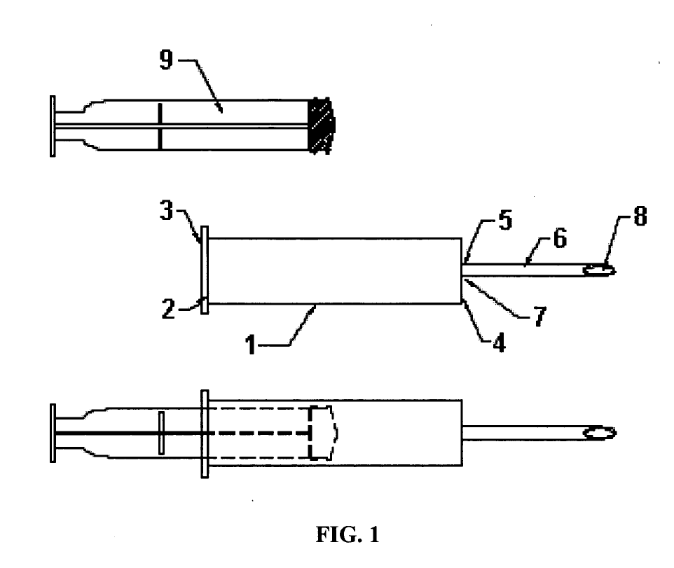

One example of such a delivery device is depicted in FIG. 1. The device includes a barrel 1 that defines a cylindrical passage 2 having a first opening 3. At the opposing end there is a wall 4 that defines a second opening 5 that typically is of a smaller diameter relative to the diameter of the first opening 3. A proximal end 7 of a filling tube 6 is provided within the second opening 5. A distal end 8 may be provided with a sharp or jagged edge. The filling tube 6 may define a single straight cylindrical passage or it may be a static mixer that defines a series of baffles. A plunger 9 is also provided that can be slidably inserted via the first opening 3 into the cylindrical passage 2 defined by the barrel 1.

The delivery device is positioned so that the distal end 8 penetrates the wall structure of the edible article and into the void of the edible article. The edible filling is placed into the volume formed by the cylindrical passage 2 defined by the barrel 1. The plunger 9 then is inserted through the first opening 3 to force the edible filling into the void of the edible article.

Another example of a delivery device can provide automated preparation of the edible article and delivery of the edible filling. A container or reservoir is provided that can hold the edible filling. At least one, and more particularly a plurality, of flexible hoses or similar delivery elements are coupled to the container so that the edible filling can flow through the hose. The distal ends of the flexible hoses are provided with sharp or jagged edges. Adjacent to each of the flexible hoses is a gas line that may run substantially the full length of the flexible hose. The air line is coupled to a pressurized gas supply (such as, for example, compressed air). The distal end of the gas line can be fitted with a needle that extends a short distance (e.g., about 1 mm to about 1 cm) beyond the distal end of the flexible hose. The pressurized gas line and the flexible hose can be activated by mechanical or electromechanical means (e.g., a foot peddle).

An operator first punctures the edible article with the gas line needle and then inflates the edible article as described above. The operator then inserts the sharp edge of the flexible hose into the inflated food article and fills the food article with the edible filling. A series of containers each containing a different edible filling can be arranged so that the operator can easily select the desired edible filling for delivery into the food article.

After the edible article has been stuffed with the edible filling, the resulting stuffed edible product is subjected to lyophilization as described above. In general, the stuffed edible product is first placed in a freezer at a temperature ranging from about −10° F. to about 10° F. in order to freeze the product. If necessary, the product can be stored for an extended period in the frozen state. The products can then be freeze dried in a batch or continuous freeze dryer over a cycle of about 2 to about 36 hours to a final moisture content of less than about 10%, typically less that about 8% or less than about 5% under a vacuum of less than about 2 Torr and a temperature of about −150° F. to about −0° F. The lyophilized stuffed edible product can be stored at ambient or lower temperature. The product may or may not be reconstituted prior to consumption.

### EXAMPLE 1

Sweet pea pods were water blanched 45-90 seconds in 190° F. to 200° F. water and then cooled to 40° F. The blanched pea pods were inflated with air using a hypodermic needle. The delivery device shown in FIG. 1 was inserted into the inflated pea pod, and used to introduce the edible filling into the inflated pea pod. Corn puree, sautéed onion puree, sautéed mushroom puree, and imitation crab puree were each individually introduced into pea pods. The stuffed pea pods were placed on a tray and frozen to 0° F. in a cold room. The frozen pea pods then were lyophilized to less than 3% moisture content at 0.5 mTorr, −120° F., 120° F. platen temperature, and 24 hours.

Having illustrated and described the principles of the invention in exemplary embodiments, it should be apparent to those skilled in the art that the illustrative embodiments can be modified in arrangement and detail without departing from such principles. In view of the many possible embodiments to which the principles of the invention can be applied, it should be understood that the illustrative embodiments are intended to teach these principles and are not intended to be a limitation on the scope of the invention. I therefore claim as my invention all that comes within the scope and spirit of the following claims and their equivalents.

1. A method, comprising:
reducing the puncture resistance of a wall structure of an edible article, where the wall structure at least partially defines at least one void of the edible article;
introducing an edible filling into the at least one void to form a stuffed food product; and
lyophilizing the stuffed food product.

2. The method of claim 1, where the edible filling and the edible article are different in composition, consistency or both.

3. The method of claim 1, where the wall structure is an outer portion of the edible article.

4. The method of claim 1, where the edible article is selected from the group consisting of pea pods, peppers, tomatoes, and bean pods.

5. The method of claim 1, where the edible filling is either flowable under refrigeration or flowable at room temperature and moisture.

6. The method of claim 1, further comprising removing portions of the edible article from the at least one void before introducing the edible filling into the at least one void.

7. The method of claim 1, where reducing the puncture resistance of the wall structure comprises heating the edible article.

8. The method of claim 1, where reducing the puncture resistance of the wall structure comprises blanching the edible article.

9. The method of claim 8, where blanching the edible article comprises exposing the edible article to water at a temperature of about 170° F. to about 210° F. for between 30 seconds and 2 minutes.

10. The method of claim 1, where reducing the puncture resistance of the wall structure comprises introducing a gas into the at least one void to at least partially inflate the edible article with the gas.

11. The method of claim 10, where the gas is introduced at a pressure from about 0.5 to about 5 pounds per square inch gauge.

12. A method, comprising:
puncturing a wall structure of an edible article;
introducing a gas into the edible article to at least partially inflate the edible article with the gas;
introducing an edible filling into the edible article to form a stuffed food product; and
lyophilizing the stuffed food product.

13. The method of claim 12, where the wall structure is an outer portion of the edible article.

14. The method of claim 12, where the edible filling is either flowable under refrigeration or flowable at room temperature and moisture.

15. The method of claim 12, further comprising heating the edible article.

16. The method of claim 12, where the gas is introduced at a pressure from about 0.5 to about 5 pounds per square inch gauge.

17. A stuffed edible food product, comprising:
an edible article including a wall structure at least partially defining at least one void of the edible article; and
an edible filling positioned within the at least one void, where the stuffed edible food product is lyophilized.

18. The stuffed edible food product of claim 17, where the wall structure is an outer portion of the edible article.

19. The stuffed edible food product of claim 17, where the edible article is selected from the group consisting of pea pods, peppers, tomatoes, and bean pods.

20. The stuffed edible food product of claim 17, where the edible filling is either flowable under refrigeration or flowable at room temperature and moisture.
